(19) United States
(12) Patent Application Publication
(10) Pub. No.: US 2016/0352835 A1
(43) Pub. Date: Dec. 1, 2016

(54) MOBILE CONTENT SHARING

(71) Applicant: Bazaarvoice, Inc., Austin, TX (US)

(72) Inventor: Christian Johannessen, Georgetown, TX (US)

(21) Appl. No.: 14/940,575

(22) Filed: Nov. 13, 2015

Related U.S. Application Data
(60) Provisional application No. 62/169,405, filed on Jun. 1, 2015.

(51) Int. Cl. H04L 29/08; H04L 29/06

(52) U.S. Cl. CPC H04L 67/1097; H04L 67/42; H04L 67/10; H04L 67/306

(57) ABSTRACT

This disclosure provides techniques usable for sharing of items of content between various computing systems and/or browsing sessions. According to some embodiments, a user may be enabled to save an item of content from one system for later use, and then have the item of content automatically become available for later use in whatever the most convenient form might be. For example, the item of content might become available via a different application on the same system, or on a different system altogether.

### CROSS-REFERENCE TO RELATED APPLICATIONS

This application claims the benefit of U.S. Provisional Application No. 62/169,405, filed Jun. 1, 2015, which is incorporated by reference herein in its entirety.

### BACKGROUND

Technical Field

This disclosure relates generally to the sharing of content between multiple devices of a user. More particularly, this disclosure may have particular relevance in the field of allowing a user to easily save items of electronic content such as web content (for example, coupon codes) for later use from another device.

Description of the Related Art

Currently, when a user encounters an item of content online (e.g., a coupon code, advertising content, or other electronic/web content), there is no easy way for that user to save the item of content for later use. It would be desirable for the user to be able simply to select the item of content and have it automatically become available for later use in whatever the most convenient form might be. For example, the user might encounter a coupon for a retailer as a banner advertisement on a website, but would prefer to be able to use the coupon code later from her smartphone via the retailer's mobile application. There is currently no easy way to accomplish this, however. This disclosure is directed to remedying this and other deficiencies in the art.

### BRIEF DESCRIPTION OF THE DRAWINGS

FIG. 1 shows a block diagram illustrating an embodiment of this disclosure.

FIG. 2 shows an example of a website including advertisements with coupon codes, according to one embodiment of this disclosure.

FIG. 3 shows an example of a smartphone application, according to one embodiment of this disclosure.

FIG. 4 shows a block diagram illustrating an embodiment of this disclosure.

FIG. 5 shows a process flow, according to one embodiment of this disclosure.

FIG. 6 shows a block diagram illustrating a computing system, according to one embodiment of this disclosure.

### DETAILED DESCRIPTION

Currently, there is no easy way for a user to discover an item of content within a browsing session on a given device or system and then use the content later from a different browsing session. For example, the different browsing session may take place from some other device (e.g., using the same type or a different type of application on the other device), or it may take place from a different application on the same device.

For the sake of concreteness and ease of exposition, much of this disclosure will refer to the example of coupon codes as the items of content. One of ordinary skill in the art with the benefit of this disclosure, however, will understand its applicability to various other types of content. For example, this disclosure is equally applicable to other commercial or non-commercial content that may be desirable to save from one device or browsing session and have available at another device or browsing session. As one example of commercial content, a link to a desired product might be saved; as an example of non-commercial content, a link to an interesting article might be saved.

In one example according to this disclosure, a user may encounter an advertisement for a product or service in the course of browsing the Internet. Such an advertisement may include a coupon code (e.g., for a discount off of the normal price of the product or service). If the user is not prepared at the moment of the encounter to take advantage of the coupon code, but is nevertheless interested in doing so at some future time, it would be desirable for the user to be able to easily save the coupon code for later, and then have it simply appear when he was ready to use it.

For example, after the user encounters a coupon code for a particular retailer and elects to save it for later use, the next time he opens his smartphone application for that retailer, the inventor has recognized that it would be useful for the coupon code to simply show up in that application. The inventor has also recognized that it would be useful for the coupon code to appear in the application even if the user had saved the coupon code in a different context—for example, in a different browsing session, from an application other that the particular retailer application, or from a different device altogether (e.g., from a web browser on a personal computer). The inventor has further recognized that it would be desirable for the coupon to appear the next time the user visits the website for the retailer, regardless of what device the user uses to visit the retailer website, and regardless of what device was being used when he originally encountered the coupon code. According to various embodiments, this disclosure may enable such functionalities, as well as others.

In order to enable such functionalities, in some embodiments it may be useful to determine and associate two (or more) pieces of information about the user: a unique identifier for the user's computing system, and an identifier for the user himself. When a request to save a coupon code is received and is associated with these two pieces of information, it may be possible to determine the identity of the individual who has submitted the request. Knowing the identity of this individual may then enable the ability to provide that coupon code to other devices of the same individual, other browsing sessions of the same device, etc.

It should be noted that various elements of this disclosure that are shown in the figures or described in the text may be used in conjunction with any of the computer systems, servers, mobile devices, other apparatuses, elements, or components disclosed herein or known in the art, among other systems. In various embodiments, some of the elements of process flows shown may be performed concurrently instead of sequentially, or in a different order than shown, or may even be omitted altogether in some cases. Additional process flow elements that are not shown may also be performed as appropriate or desired. In some embodiments, different elements of process flows may be performed by the same system or different systems.

One of ordinary skill in the art with the benefit of this disclosure will understand that various types of database or other storage technologies may be used in accordance with this disclosure. One of ordinary skill in the art with the benefit of this disclosure will also understand that the teachings herein are applicable to various types of situations in which sharing content among multiple devices, applications, and/or browsing sessions is a goal, and this disclosure need not be limited to any specific situation described herein.

Various embodiments of this disclosure refer to “user-generated content” or “UGC.” As used herein, these terms refer to text, audio, video, or any other information-carrying medium that is generated by a user who may be a consumer of something (e.g., of goods, a product, a website, a service), a purchaser of that something, or may otherwise have an interest in that something. UGC includes, in various embodiments, content such as user reviews, stories, ratings, comments, problems, issues, questions, answers, or opinions.

Various embodiments of this disclosure refer to the term “information sharing service.” For purposes of this disclosure, an information sharing service is a computing system including a data store that has an interface for accepting and providing information. In some instances, information sharing services may provide information to end users. In other instances, information sharing services may provide information to other information sharing services. Information sharing services may in some instances operate using account logins, but in other instances accounts may not need to be used. One example of an information sharing service is Bazaarvoice®, which sometimes provides items of UGC (such as user reviews, ratings, etc. regarding products or services) for inclusion on websites of retailers, manufacturers, etc. Broadly speaking, such retailers and manufacturers may also be considered as operating information sharing services. Separate information sharing services typically have separate data stores and/or separate interfaces to their information.

Various embodiments of this disclosure also refer to the term “browsing session.” As used herein, a browsing session is not to be considered as a technical term (e.g., such as in the OSI Session Layer), but is to be broadly understood as the use of an application (e.g., web browser, smartphone application, etc.) to access information, such as information from an information sharing service. Various items of state data such as cookies, etc. may be associated with a particular browsing session. If all of the state data associated with a particular browsing session were deleted, a separate browsing session could then be initiated using the same application. For example, if a user logged into an information sharing service with a web browser, and then cleared the web browser's cache, cookies, etc., and then logged back into the information sharing service, these would typically be considered two separate browsing sessions.

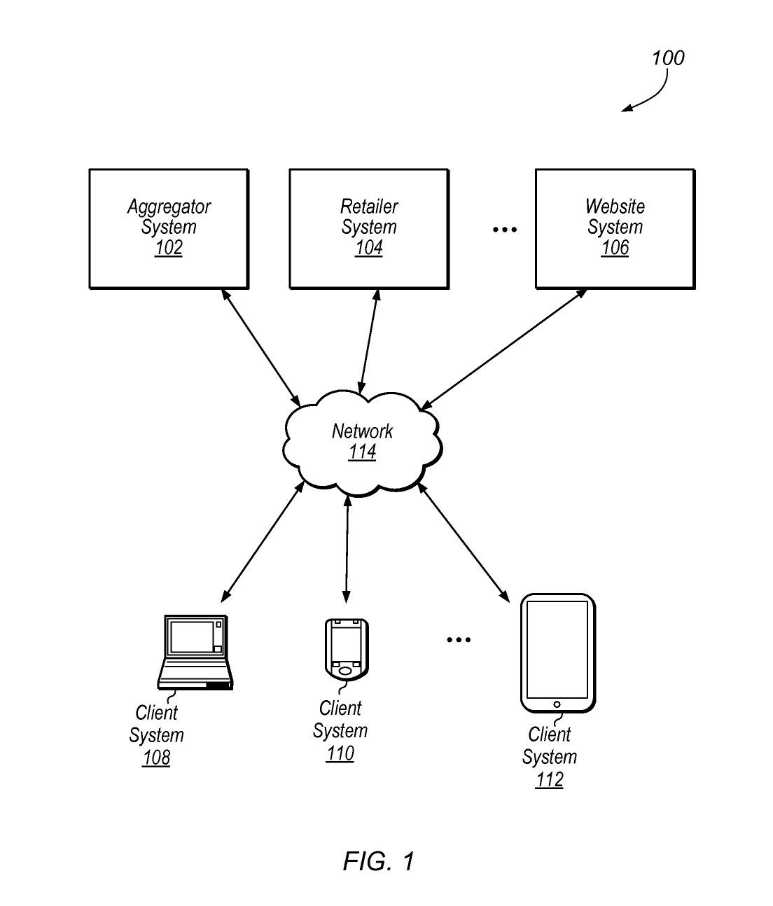

Turning now to FIG. 1, an embodiment of the present disclosure is shown in block diagram 100. In block diagram 100, aggregator system 102, one or more retailer systems 104, and one or more website systems 106 are shown connected via network 114. Each of these systems may represent one or more server computing systems; network 114 may in various cases represent the Internet, an intranet, or any other suitable computer network. In general, retailer systems 104 may be associated with retailers and may provide retail web pages for such retailers. Website systems 106 may serve websites of any other kind.

Also shown connected to network 114 are client system 108, client system 110, and client system 112. In this example, each of the client systems is associated with a single user, and they simply represent different ways for the user to interact with network 114. The client systems are shown as a personal computer, a smart phone, and a tablet device; one of ordinary skill in the art with the benefit of this disclosure, however, will understand that any suitable client systems may be used.

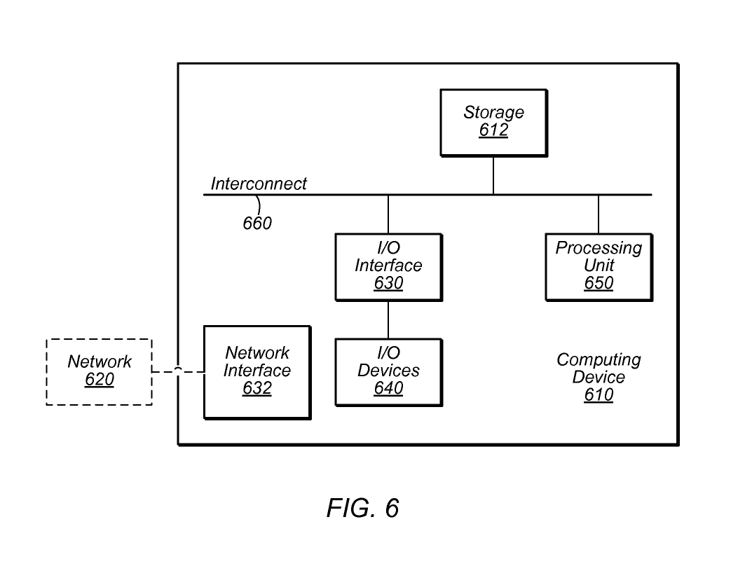

FIG. 1 thus includes several computing systems. In general, within this disclosure, the term “computing system” may be understood to refer to any system that includes one or more computers or other computing devices. For example, in some cases a server computing system may in fact be implemented as a cluster of two or more individual server computers or constituent computing devices. One embodiment of such a constituent computing device is described below with reference to FIG. 6.

According to one example, aggregator system 102 may interface with any number of retailer systems 104 and/or website systems 106 to provide content that may be displayed within web pages served by such systems to any of client systems 108, 110, and 112. For example, in one embodiment, each retailer system 104 is controlled by one or more organizations (e.g., retail organizations) that have a relationship with the organization that controls aggregator system 102, wherein aggregator system 102 provides UGC for display within web pages served by retailer systems 104. Such UGC may in various embodiments be provided via retailer systems 104, or directly to end users of such web pages. The organizations controlling website systems 104 may also have business relationships with the organization controlling aggregator system 102 (e.g., aggregator system 102 may provide ads or other content (such as UGC) to be included in the websites served by website systems 104). Each of these organizations and/or systems may be considered an information sharing service. In the present example, aggregator system 102 may provide UGC such as user reviews of products or services that are sold via the retailer websites served by retailer systems 104. This UGC may be incorporated into the retailer websites.

Further, in addition to arrangements with retailer systems 104, the information sharing service that controls aggregator system 102 may have arrangements with various ones of the information sharing services controlling website systems 106. Such arrangements may take various forms. In one example, website systems 106 may serve ads that have been provided by aggregator system 102 when serving web pages. In other examples, UGC or various other types of content may be provided by aggregator system 102 to be included within web pages served by website systems 106.

In some cases, in the course of providing content via the websites served by any of either retailer systems 104 or website systems 106 to client systems 108, 110, or 112, aggregator system 102 may also provide additional information for storage on such client systems. For example, elements of tracking or identification information may be stored in client-side persistent storage. For example, in an embodiment using a web browser (e.g., for client system 108), client-side persistent storage may be in the form of cookies, local shared objects, localStorage, etc. The term “cookie” is used herein in accordance with its customary meaning in the art. In an embodiment using an application such as a smartphone application, various other types of client-side persistent storage may be used, such as any type of application-specific storage.

Typically, such elements of tracking or identification information may include a unique identifier associated with the system on which it is stored (e.g., client system 108, 110, or 112). Such a “unique” identifier may in some embodiments be globally unique, or it may in other embodiments be unique within a given context. For example, a unique identifier may be unique within the context of a given information sharing service. The unique identifier associated with the client system is one of the two pieces of information about the user that were noted above: a unique identifier for the user's computing system.

The second of the two pieces of information about the user that were noted above (that is, an identifier for the user himself) may also be determined according to the embodiment shown in FIG. 1. For example, the user may use a client device (e.g., client system 108) to log in to a retailer web site served by one of retailer systems 104, logging in via the use of a user identifier and, in some cases, a password. For example, the user identifier may be an email address. In some cases, the user identifier may be unique as to that particular retailer, but not necessarily the same across all retailers. For example, a user identifier might be a login name or customer number for a user, within the context of a particular retailer website or application. When the user logs in to that retailer web site, retailer system 104 may detect the presence of the unique identifier associated with the client system, which was previously left by aggregator system 102.

In response to detecting the presence of the unique identifier associated with the client system, retailer system 104 may send data indicative of the unique identifier and the user identifier to aggregator system 102, which may inform aggregator system 102 that this particular client device (identified by the unique identifier) is being used by this particular user (identified by the user identifier). Aggregator system 102 may be informed of such information either directly by retailer system 104, or retailer system 104 may cause the client system to provide such information to aggregator system 102. For example, aggregator system 102 may be informed via an XMLHttpRequest call that includes the unique identifier and the user identifier (or a hashed version thereof, or other data that is merely indicative of such identifiers), or via any other suitable technique.

In response to receiving the unique identifier and the user identifier, aggregator system 102 may establish a user profile for the user. The user profile may include any known information about the user, typically including at least the unique identifier for the user's computing system, and the user identifier that the user has used to log into retailer system 104.

If aggregator system 102 detects that a user profile already exists for this user, that user profile may be updated with any information that is newly available based on the new information from retailer system 104. For example, over time, a user profile may be built up that includes unique identifiers for each of client systems 108, 110, and 112, as well as for various user identifiers from different ones of retailer systems 104. Because all of these identifiers relate to the same user, they may all be stored within the same user profile.

Once the user profile has been established including a unique identifier for (for example) client system 108 and a user identifier that identifies the user to retailer system 104, sufficient information is in place to allow the user to save a coupon code associated with retailer system 104. Such a coupon code may be presented to the user in any suitable way, such as via a web advertisement. For example, any of retailer systems 104 and/or website systems 106 may serve a web page to the user with a coupon code, which may be provided by aggregator system 102.

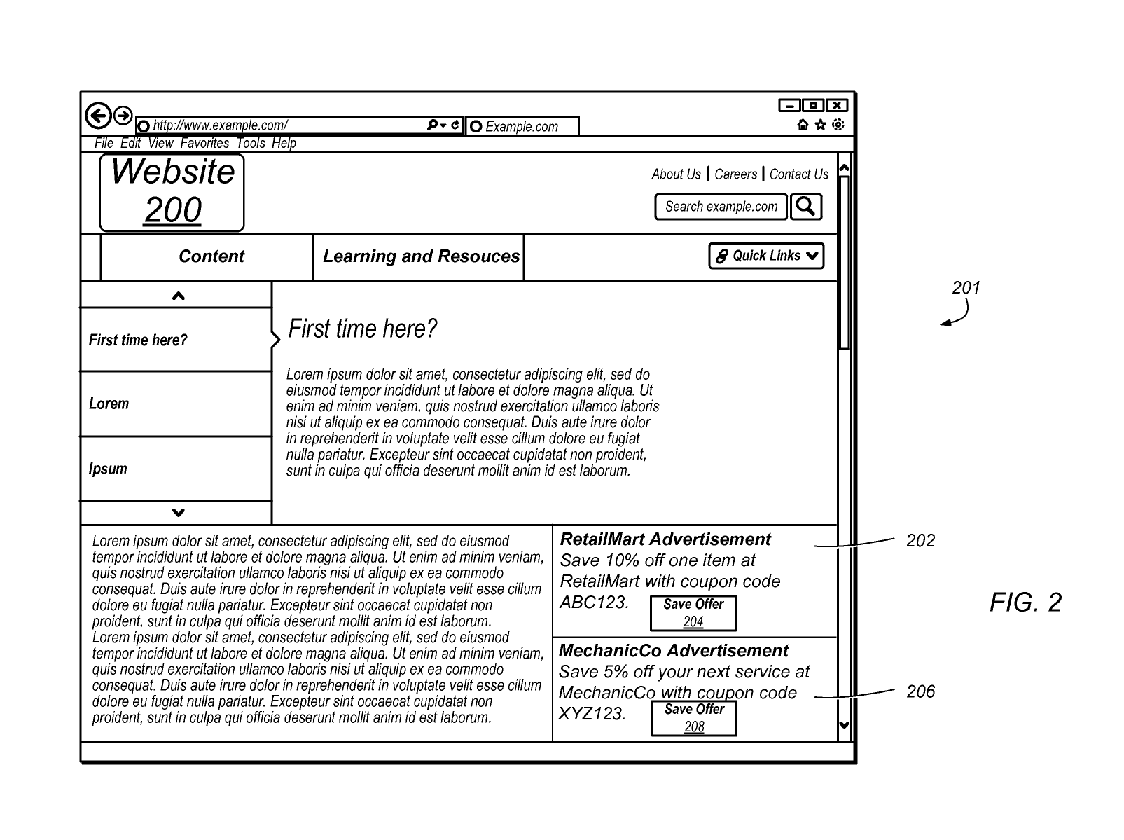

Once the user has been presented with a coupon code, the user may elect to save the coupon code for later use (discussed in more detail below with reference to FIG. 2). Aggregator system 102 may then record this election via (for example) an API call to update the user's profile with information regarding the coupon code.

Because the unique identifier associated with client system 108 has already been associated with the user identifier for retailer system 104 in the user profile kept by aggregator system 102, it is possible to present the desired coupon code (and any other saved coupon codes) to the user the next time the user logs into the website for retailer system 104, a smartphone application associated with retailer system 104, etc. Presenting the desired coupon code may be accomplished in various ways, for example via an interface between retailer system 104 and aggregator system 102 that may be embedded in such website or application.

In some embodiments, the events described above may occur in a different order. For example, in some cases, the user may log into the retailer website prior to the unique identifier being stored on the client system. In other cases, the unique identifier stored on the client system may be created by the very same website that the user is logging into.

In some instances, a user may attempt to save a coupon code before a user profile has been fully established. In such a situation, aggregator system 102 may simply trigger a login event for retailer system 104, directing the user to a page that will allow such a login. This situation may be seen as less seamless than the situation in which the user profile is already established and everything “just works,” but it is a relatively minor inconvenience. Once the login event has been triggered, any future saving of coupon codes may not necessitate additional logins, because the user profile will already be in existence.

In some instances, it may not be necessary to store a new unique identifier at the client system. Instead, it may be possible to select one of the already-stored unique identifiers as applicable. In a non-web-browser embodiment (e.g., for an application running on client system 110 or 112), for example, rather than storing new information in client-side persistent storage, an existing hardware unique identifier may instead be determined when (or before) the user attempts to save the coupon code. In the context of an application running on client system 110 or 112, one way of determining the unique identifier may be in the course of serving advertisements to be displayed within the application. For example, an IDFA identifier may be determined in the case of an Apple® device, or an advertising ID may be determined in the case of an Android® device. Various other options for determining a unique identifier for the client system will be apparent to one of ordinary skill in the art having the benefit of this disclosure.

Turning now to FIG. 2, an embodiment is shown in which a user has browsed to web page 201 of website 200, which may have been served by any one of retailer systems 104 or website systems 106. As one of ordinary skill in the art with the benefit of this disclosure will understand, web page 201 may include content from multiple sources/websites. As shown, web page 201 includes coupon 202 for a product and coupon 206 for a service. Coupon 202 includes save offer button 204, and coupon 206 includes save offer button 208. If the user is interested in coupon 202 for RetailMart but does not desire to do any shopping at that very moment, she may select (e.g., click or tap) on save offer button 204 to save coupon 202 for later use. Code included within coupon 202 and/or save offer button 204 (e.g., JavaScript® code in some embodiments) may transmit information to the aggregator indicating that coupon 202 should be associated with the user's user profile.

As noted above, different processes may take place at this point, depending on whether or not the user already has an established user profile linking the unique identifier associated with the client system being used to the user identifier for RetailMart. If the user does already have an established user profile, coupon 202 may be associated with that user profile, and save offer button 204 may (for example) be updated to indicate that coupon 202 has been successfully saved. If the user does not yet have an established user profile, a login event may be triggered that will allow the completion of the user profile, and coupon 202 may then be associated with the newly created user profile.

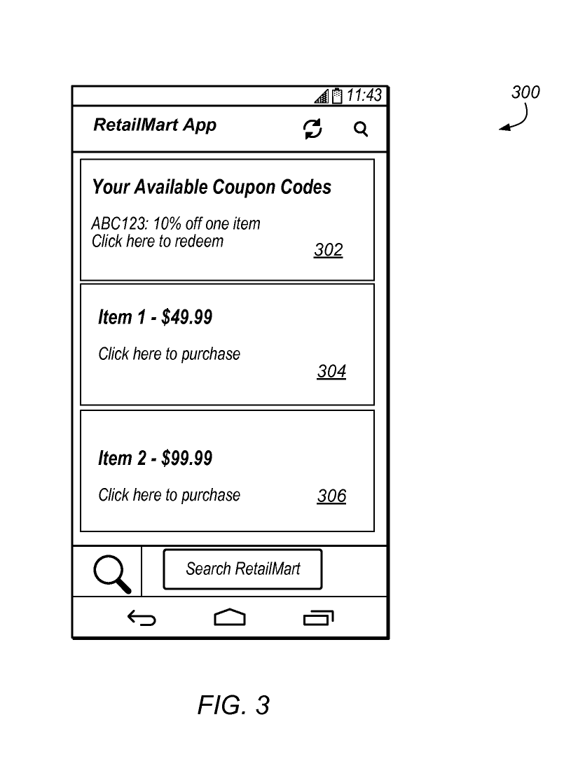

Turning now to FIG. 3, a related embodiment is shown in which the same user has later opened smartphone application 300 for RetailMart. As shown, in addition to user interface elements 304 and 306 allowing the user to purchase products, a new coupon user interface element 302 is also shown, which lists all available coupon codes saved by the user that are usable at RetailMart. As shown, coupon user interface element 302 includes the same coupon code (ABC123) that was saved in FIG. 2.

Accordingly, from the user's perspective, the situation depicted in FIGS. 2 and 3 is seamless. The user discovers coupon 202 in the course of browsing the web on one device, decides to save it, and the coupon appears the next time she shops at RetailMart (e.g., via the RetailMart application).

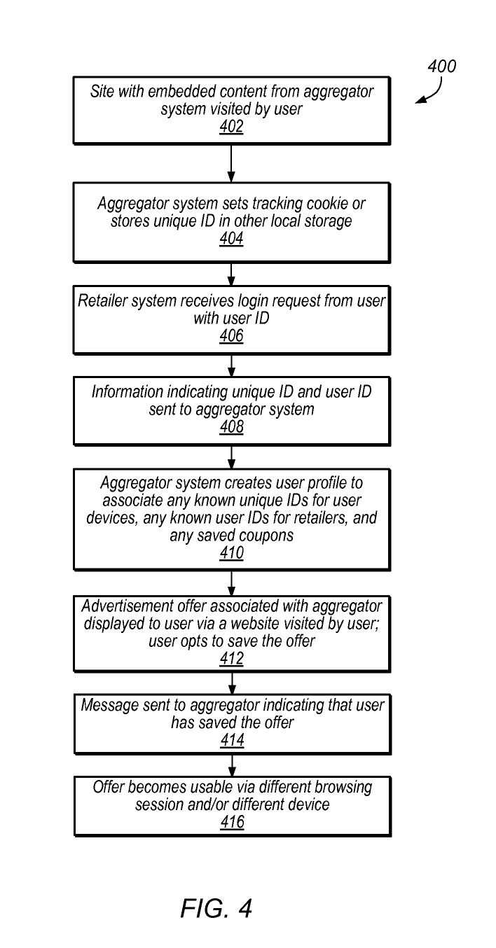

Turning now to FIG. 4, process flow 400 for saving an offer according to one embodiment is shown. Flow begins at step 402.

At step 402, a user uses a client system to visit a site (e.g., a web site or an application) that includes embedded content from an aggregator system. For example, as discussed above, this embedded content may in one embodiment be UGC that the aggregator system has provided for use at the site. Flow proceeds to step 404.

At step 404, the aggregator system sets, via the embedded content, a tracking cookie indicating a unique identifier for the client system. In other embodiments, the aggregator may store the unique identifier in other ways in local storage on the client system. In yet other embodiments, the aggregator may simply detect and record a unique identifier that is already associated with the client system. Flow proceeds to step 406.

At step 406, the user logs into a retailer system with a user identifier. This user identifier typically identifies the user within the context of that retailer system, and it may or may not be a globally unique identifier. For example, different retailers may use different user identifiers for the same user. Flow proceeds to step 408.

At step 408, information indicative of the unique identifier and the user identifier is sent to an aggregator system. Such information may in various instances be sent from the user's computing system, or from the retailer system. This information may be the unique identifier and the user identifier themselves, or hashed versions thereof, or any other suitable indication of those identifiers. Flow proceeds to step 410.

At step 410, the aggregator, having received the information indicative of the unique identifier and the user identifier, sets up a user profile (if a profile for this user does not yet exist). The user profile associates any known unique identifiers, user identifiers, and saved coupon codes for this user in a single profile. If the profile already exists, then the aggregator may simply associate this new data with the existing profile. Flow proceeds to step 412.

At step 412, the user browses to a website, sees an advertisement offer for the retailer, and opts to save the advertisement offer for later use. Typically, such an advertisement offer will be served by or otherwise associated with the aggregator. Flow proceeds to step 414.

At step 414, a message is sent to the aggregator indicating that the user has saved the advertisement offer. This message may be sent by the user's own system, or by the website on which the offer was found. Flow proceeds to step 416.

At step 416, the offer becomes available to the user via a different browsing session and/or a different device. In some cases, the offer may become available via a plurality of different browsing sessions and/or different devices. Flow ends at step 416.

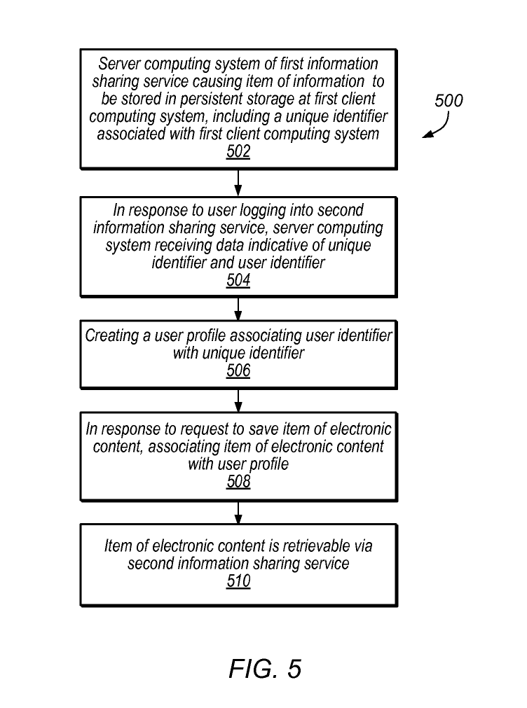

Turning now to FIG. 5, another process flow 500 according to a similar embodiment of the disclosure is shown. Flow begins at step 502.

At step 502, a server computing system of a first information sharing service causes an item of information to be stored in persistent storage at a first client computing system. The first item of information includes a unique identifier associated with the first client computing system. In various instances, the item of information may be a cookie or any other suitable type of local storage. Flow proceeds to step 504.

At step 504, in response to the user logging into a second information sharing service, the server computing system receives data indicative of the unique identifier and the user identifier. Typically, the user identifier is what is used to log in. Flow proceeds to step 506.

At step 506, a user profile associating the user identifier with the unique identifier is created. Flow proceeds to step 508.

At step 508, in response to a request from the user to save an item of electronic content (e.g., web content such as a coupon code), the item of electronic content is associated with the user profile. The item of web content may have been provided by the first information sharing service in some instances, or by some other service or system in other instances. Flow proceeds to step 510.

At step 510, the item of electronic content becomes retrievable by the user via the second information sharing service. For example, the item of electronic content may become available via a different browsing session of the same application, a different application, a different client computing system, etc. Flow ends at step 510.

Turning now to FIG. 6, a block diagram of a computing device (which may also be referred to as a computing system) 610 is depicted, according to some embodiments. Computing device 610 may be used to implement various portions of this disclosure. Computing device 610 is one example of a device that may be used as a mobile device, a server computing system, or any other computing system implementing portions of this disclosure.

Computing device 610 may be any suitable type of device, including, but not limited to, a personal computer system, desktop computer, laptop or notebook computer, mobile phone, mainframe computer system, web server, workstation, or network computer. As shown, computing device 610 includes processing unit 650, storage subsystem 612, input/output (I/O) interface 630 coupled via interconnect 660 (e.g., a system bus). I/O interface 630 may be coupled to one or more I/O devices 640. Computing device 610 further includes network interface 632, which may be coupled to network 620 for communications with, for example, other computing devices.

As described above, processing unit 650 includes one or more processors. In some embodiments, processing unit 650 includes one or more coprocessor units. In some embodiments, multiple instances of processing unit 650 may be coupled to interconnect 660. Processing unit 650 (or each processor within processing unit 650) may contain a cache or other form of on-board memory. In some embodiments, processing unit 650 may be implemented as a general-purpose processing unit, and in other embodiments it may be implemented as a special purpose processing unit (e.g., an ASIC). In general, computing device 610 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions or computer instructions from any suitable form of non-transitory computer-readable media to perform specified operations.

Storage subsystem 612 is usable by processing unit 650 (e.g., to store instructions executable by and data used by processing unit 650). Storage subsystem 612 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 612 may consist solely of volatile memory in some embodiments. Storage subsystem 612 may store program instructions executable by computing device 610 using processing unit 650, including program instructions executable to cause computing device 610 to implement the various techniques disclosed herein.

I/O interface 630 may represent one or more interfaces and may be any of various types of interfaces configured to couple to and communicate with other devices, according to various embodiments. In some embodiments, I/O interface 630 is a bridge chip from a front-side to one or more back-side buses. I/O interface 630 may be coupled to one or more I/O devices 640 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“Based On.” As used herein, this term is used to describe one or more factors that affect a determination. This term does not foreclose additional factors that may affect a determination. That is, a determination may be solely based on those factors or based only in part on those factors. Consider the phrase “determine A based on B.” This phrase connotes that B is a factor that affects the determination of A, but it does not foreclose the determination of A from also being based on C. In other instances, A may be determined based solely on B.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component.

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Although specific embodiments have been described above, these embodiments are not intended to limit the scope of the present disclosure (even where only a single embodiment is described with respect to a particular feature). Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Although some example embodiments are described as providing various advantages, any particular embodiment according to this disclosure may provide some, all, or even none of such advantages.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
a server computing system of a first information sharing service causing an item of information to be stored in persistent storage at a first client computing system, wherein the item of information includes a unique identifier associated with the first client computing system;
in response to a user of the first client computing system logging into a second information sharing service, the server computing system receiving, from the first client computing system, data indicative of the unique identifier and a user identifier that identifies the user within the second information sharing service;
the server computing system creating a user profile for the user that associates the user identifier with the unique identifier; and
in response to a request from the user to save an item of electronic content, the server computing system associating the item of electronic content with the user profile;
wherein the associating causes the item of electronic content to be retrievable by the user via the second information sharing service.

2. The method of claim 1, further comprising:
the first information sharing service transmitting user-generated content (UGC) relating to products or services to a plurality of other information sharing services including at least one retailer information sharing service.

3. The method of claim 2, wherein the plurality of other information sharing services includes the second information sharing service.

4. The method of claim 2, wherein the item of information is caused to be stored at the first client computing system in response to the UGC being transmitted by the first information sharing service.

5. The method of claim 1, wherein the item of information is stored in persistent storage as a cookie.

6. The method of claim 1, wherein the logging into the second information sharing service precedes the server computing system causing the item of information to be stored.

7. The method of claim 1, wherein the server computing system transmitting the item of electronic content to the user precedes the logging into the second information sharing service.

8. The method of claim 7, wherein the request from the user to save the item of electronic content triggers a prompt at the first client computing system for the logging into the second information sharing service.

9. An article of manufacture including a non-transitory, computer-readable medium having instructions coded thereon that, in response to execution by a computing system, cause the computing system to carry out operations comprising:
causing an item of information that is associated with a first information sharing service to be stored in persistent storage at a first client computing system, wherein the item of information includes a unique identifier associated with the first client computing system;
in response to a login event of the first client computing system at a website of a second information sharing service, the computing system receiving, from the first client computing system, data indicative of the unique identifier and a user identifier that identifies a user of the first client computing system within the second information sharing service;
creating a user profile for the user that associates the user identifier with the unique identifier; and
in response to a request from the user to save an item of electronic content, associating the item of electronic content with the user profile;
wherein the associating causes the item of electronic content to be retrievable by the user via the second information sharing service.

10. The article of claim 9, wherein the computing system includes a plurality of individual computing devices.

11. The article of claim 9, wherein the item of electronic content is an item of web content.

12. The article of claim 9, wherein the item of electronic content is retrievable by the user via the second information sharing service at a second client computing system.

13. The article of claim 9, wherein the item of information is stored in persistent storage prior to the login event.

14. The article of claim 9, wherein the item of electronic content is provided to the user as a portion of a second, different website.

15. The article of claim 9, wherein the data indicative of the user identifier is the user identifier.

16. The article of claim 9, wherein the data indicative of the user identifier includes a hashed version of the user identifier.

17. A system, comprising:
at least one processor; and
a memory having instructions stored thereon that, in response to execution by the at least one processor, cause the system to carry out operations comprising:
causing an item of information that is associated with a first information sharing service to be stored in persistent storage at a first client computing system, wherein the item of information includes a unique identifier associated with the first client computing system, and wherein the item of information is associated with a first browsing session at the first client computing system;
in response to a user of the first client computing system logging into a second information sharing service, the system receiving, from the first client computing system, data indicative of the unique identifier and a user identifier that identifies the user to the second information sharing service;
creating a user profile for the user that associates the user identifier with the unique identifier; and
in response to a request from the user to save an item of content, associating the item of content with the user profile;
wherein the associating causes the item of content to be retrievable by the user in a separate browsing session.

18. The system of claim 17, wherein the separate browsing session is initiated via a different type of application and at a different client computing system than the first browsing session.

19. The system of claim 17, wherein the first browsing session is initiated via a web browser on the first client computing system, and wherein the separate browsing session is initiated via a smartphone application.

20. The system of claim 17, wherein the separate browsing session is initiated via a different application on the first client computing system.
